(19) United States
(12) Patent Application Publication
(10) Pub. No.: US 2021/0156492 A1
(43) Pub. Date: May 27, 2021

(54) LIQUID FLOW REGULATION DEVICE

(71) Applicant: Consolidated Foam, Buffalo Grove, IL (US)

(72) Inventors: Daniel R. Levitt, Highland Park, IL (US); Jonathan Meehan, Des Plaines, IL (US); Peter Ogilvie, Kildeer, IL (US); Felipe Garcia, Chicago, IL (US)

(21) Appl. No.: 17/101,361

(22) Filed: Nov. 23, 2020

Related U.S. Application Data
(60) Provisional application No. 62/938,517, filed on Nov. 21, 2019.

(51) Int. Cl. F16K 31/524; F16K 21/00

(52) U.S. Cl. CPC F16K 31/52441; F16K 21/00

(57) ABSTRACT

A flow regulation device for liquid having a body with an inlet opening, an outlet opening, and a cavity between the two openings. An actuating means is disposed in the cavity for stopping and starting the flow of liquid through said device. The actuating means is configured to be moved in a first direction to start the flow of liquid through said device and in the first direction to stop the flow of liquid through said device. The actuating may comprise an upper button and a lower cam.

### RELATED APPLICATIONS

This application claims priority to U.S. Patent Application Ser. No. 62/938,517 filed on Nov. 21, 2019, the entirety of which is incorporated herein by reference.

### FIELD OF THE INVENTION

The present invention relates to flow control devices and, more particularly, to a liquid flow regulation device useful with, for example, garden hoses and gardening implements like sprinklers and water sprayers.

### BACKGROUND OF THE INVENTION

Most homes and residential buildings have a spigot (or hose bib) for connecting to a hose for supplying water to outdoor spaces. For example, many homes and residential buildings have gardens and other plants grown by the residents. In many regions, rain is not consistent enough to support the plants grown by the residents. Accordingly, water is provided to the plants via a hose or other flexible conduit from the spigot. Similarly, many people use the water from the spigot for other activities like washing a car, cleaning a sidewalk, or other water-based activities.

For some people, actuating a spigot, often by turning the wheel handle may be difficult as it is difficult to grasp and turn on and off Additionally, other flow control devices, like shut off valves, may be difficult to grasp and/or operate for some individuals.

Accordingly, there is a need for a device which provides a way to control the flow of liquid which can be more easily controlled.

### SUMMARY OF THE INVENTION

A new liquid flow regulation device has been invented. The device controls the flow of liquid via a push-button actuating mechanism. The push button is a control action that can be utilized by individuals which find current control devices difficult to operate. Additionally, the push-button actuating mechanism may be configured to move in the same direction to both start the flow of liquid through said device and to stop the flow of liquid through said device. Again, such movement is believed to make it easier to use.

Accordingly, in at least one aspect of the present invention, the present invention may be generally characterized as providing a liquid flow regulation device including: a body having an inlet opening and an outlet opening and cavity between the inlet and outlet openings; and, an actuating means disposed in the cavity for stopping and starting the flow of liquid through said device. The actuating means may be configured to be moved in a first direction to start the flow of liquid through said device and in the first direction to stop the flow of liquid through said device. The actuating means may include an upper button and a lower cam.

The cavity may have a longitudinal axis that may be perpendicular to an axis of the device extending from the inlet end to the outlet end. Alternatively, the cavity may have a longitudinal axis that is angled relative to an axis of the device extending from the inlet end to the outlet end.

Accordingly, in at least one other aspect of the present invention, the present invention may be generally characterized as providing a liquid flow regulation device as described herein.

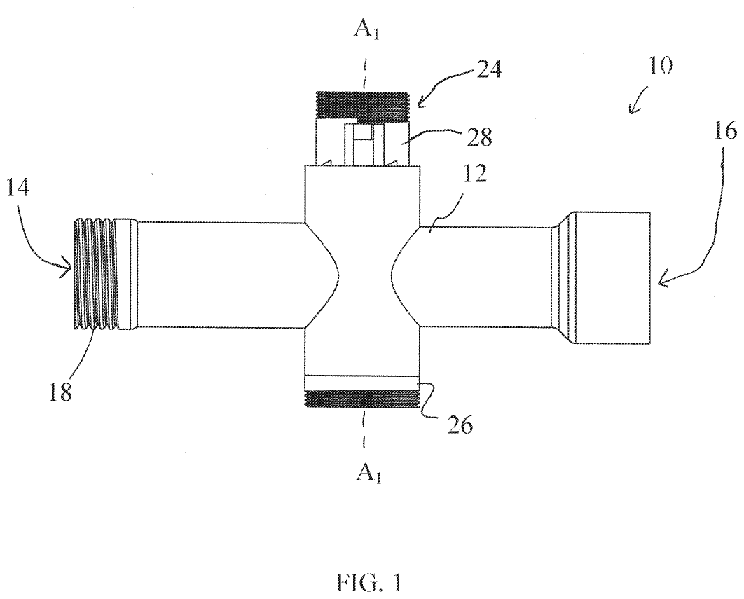

Similarly, in at least one other aspect of the present invention, the present invention may be generally characterized as providing a liquid flow regulation device as depicted in FIGS. 1 to 6.

Furthermore, in at least one other aspect of the present invention, the present invention may be generally characterized as providing method of controlling a flow of water using a liquid flow regulation device as depicted or described herein.

In one particular aspect, the present invention may be characterized as providing a liquid flow regulation device including a body having an inlet opening and an outlet opening and cavity between the inlet and outlet openings, and, an actuating means disposed in the cavity configured to start and stop the flow of liquid through said liquid flow regulation device. The actuating means is configured to be moved in a first direction to start a flow of liquid through said device and in the first direction to stop the flow of liquid through said device. The cavity may have a longitudinal axis that is perpendicular to an axis of the device extending from the inlet opening to the outlet opening. The cavity alternatively may have a longitudinal axis that is angled between 90 and 180 relative to an axis of the device extending from the inlet opening to the outlet opening.

The actuating means may include an upper button and a lower cam. The lower cam may have a surface with a configuration formed by one or more ramps, stops, and gaps, and the upper button may have a lower surface with a complementary configured configuration formed by one or more ramps, stops, and gaps. The lower cam may have a center post configured to receive a center cavity in the upper button. The flow regulation device may also include a spring urging the lower cam towards the upper button.

The lower cam may include a body with a through hole that in an alignment configuration, allows the flow of liquid, from the inlet opening, through the cavity, and out of the flow regulation device at the outlet opening. The device may further include a gasket having a first end and a second end and being disposed between one of the inlet opening and the outlet opening and the body of the lower cam. The first end of the gasket may corresponds to the body of the device, and the second end of the gasket has a non-planar outer edge that is shaped to have an arc-shape, when viewed from the top, so that the body of the lower cam sits in the second end of the gasket.

The flow regulation device may further include a moveable shaft engaging the lower cam. The moveable shaft may have an annular seal configured to engage a seal seat and to move between a blocking position and a free position. In the blocking position the annular seal contacts the seal seat and prevents the flow of liquid passed the annular seal. The flow regulation device of claim 11 may further include a spring biasing the moveable shaft in the blocking position. The moveable shaft may further include a plurality of wings to provide space for the flow of liquid. One or more of the wings from the plurality of wings may include an extension which is received in a slot in the body of the device.

In at least one aspect, a liquid flow regulation device is provided having a body with an inlet opening and an outlet opening and cavity between the inlet and outlet openings, and an actuating means disposed in the cavity configured to start and stop a flow of liquid through said liquid flow regulation device. The cavity has a longitudinal axis that is perpendicular to an axis of the device extending from the inlet opening to the outlet opening. The actuating means include an upper button and a lower cam. The lower cam has a through hole for liquid to pass therethrough and a surface with a configuration formed by one or more ramps, stops, and gaps. The upper button has a lower surface with a complementary configured configuration formed by one or more ramps, stops, and gaps.

In at least one aspect, a liquid flow regulation device is provided having a body having an inlet opening and an outlet opening and cavity between the inlet and outlet openings, and an actuating means disposed in the cavity configured to start and stop a flow of liquid through said liquid flow regulation device. The cavity has a longitudinal axis that is angled between 90 and 180 relative to an axis of the device extending from the inlet opening to the outlet opening. The actuating means include an upper button, a lower cam, and a moveable shaft engaging the lower cam. The moveable shaft includes an annular seal configured to engage a seal seat and to move between a blocking position and a free position. In the blocking position the annular seal contacts the seal seat and prevents the flow of liquid passed the annular seal. The lower cam has a surface with a configuration formed by one or more ramps, stops, and gaps. The upper button has a lower surface with a complementary configured configuration formed by one or more ramps, stops, and gaps. The moveable shaft also includes a plurality of wings to provide space for the liquid to flow.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

FIG. 1 is a side view of a device according to one or more embodiments of the present invention;

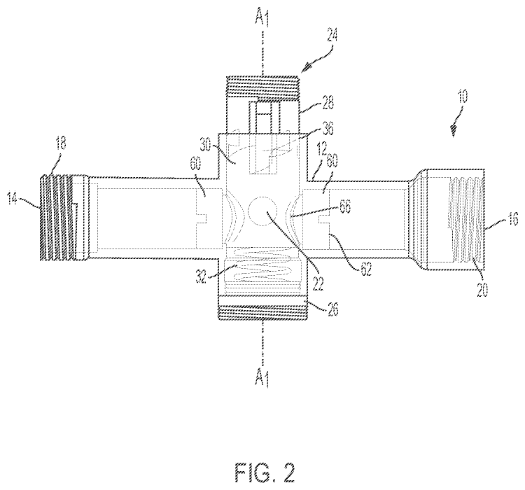

FIG. 2 is a side, see-through view of the device depicted in FIG. 1;

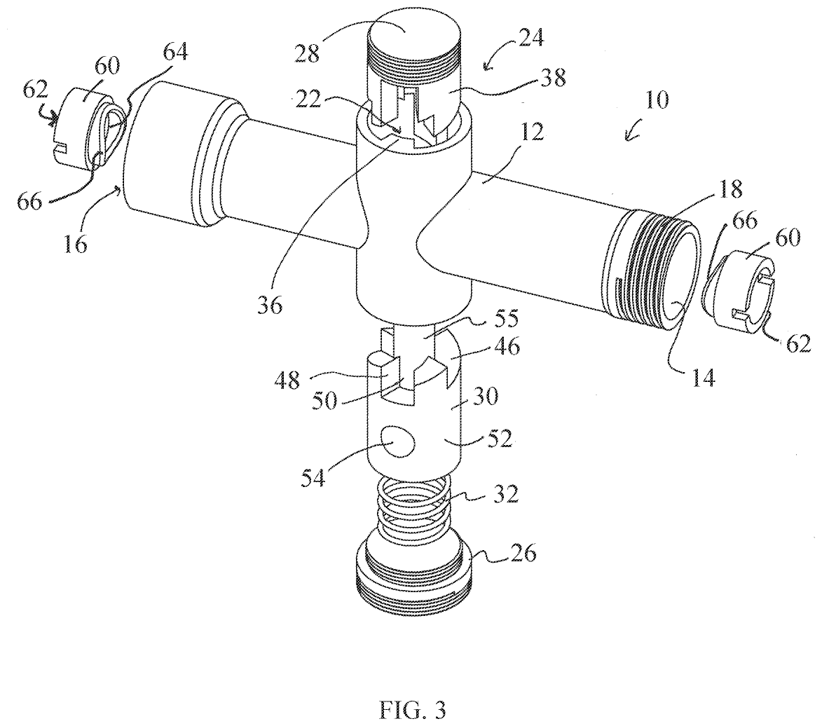

FIG. 3 is a perspective, exploded view of the device depicted in FIG. 1;

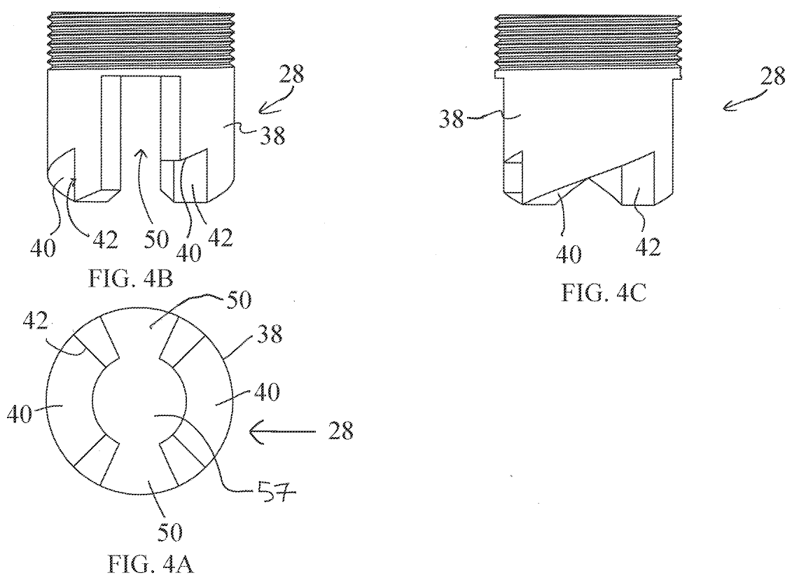

FIG. 4A is a top view of an upper button cam from the device depicted in FIG. 1;

FIG. 4B is a front view of the upper button cam from the device depicted in FIG. 1;

FIG. 4C is a side view of the upper button cam from the device depicted in FIG. 1;

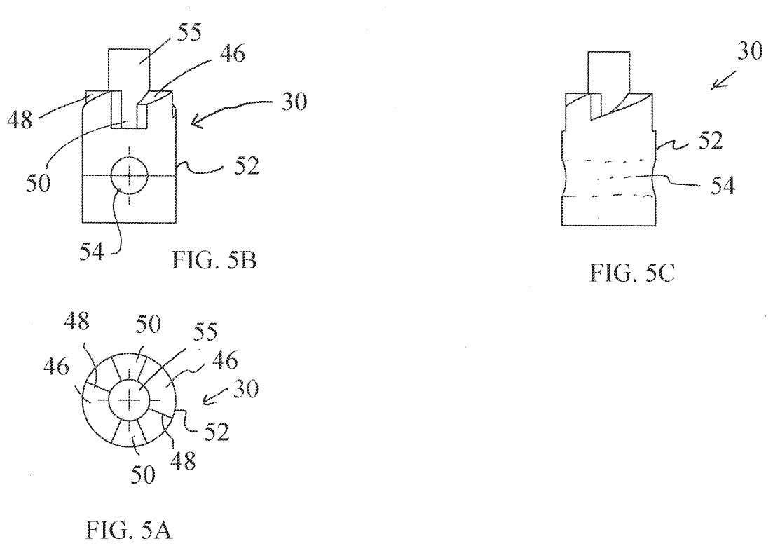

FIG. 5A is top view of a lower cam from the device depicted in FIG. 1;

FIG. 5B is front view of the lower cam from the device depicted in FIG. 1;

FIG. 5C is a side view of the lower cam from the device depicted in FIG. 1;

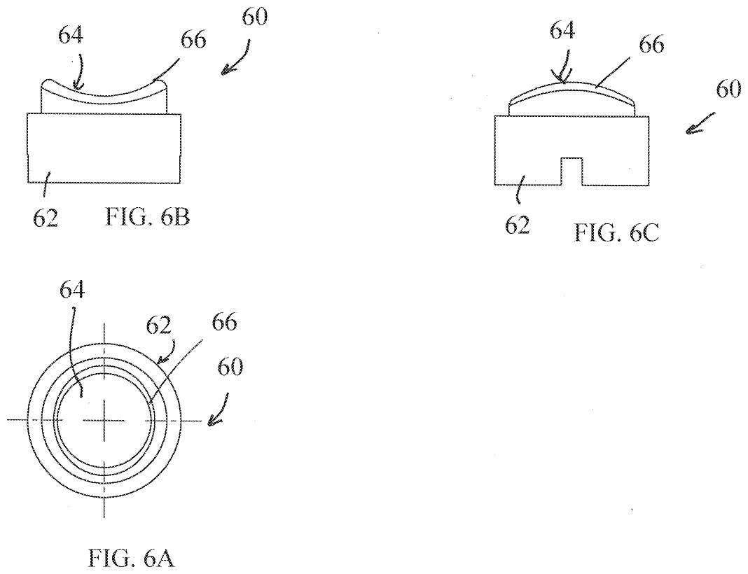

FIG. 6A is top view of an O-ring gasket from the device depicted in FIG. 1;

FIG. 6B is front view of the O-ring gasket from the device depicted in FIG. 1;

FIG. 6C is a side view of the O-ring gasket from the device depicted in FIG. 1;

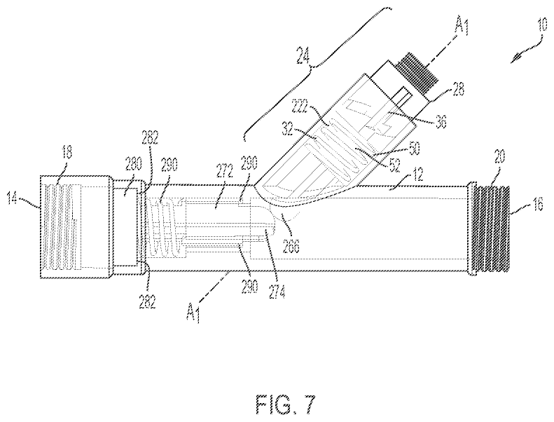

FIG. 7 is a side, see-through view of another device according to one or more embodiments of the present invention;

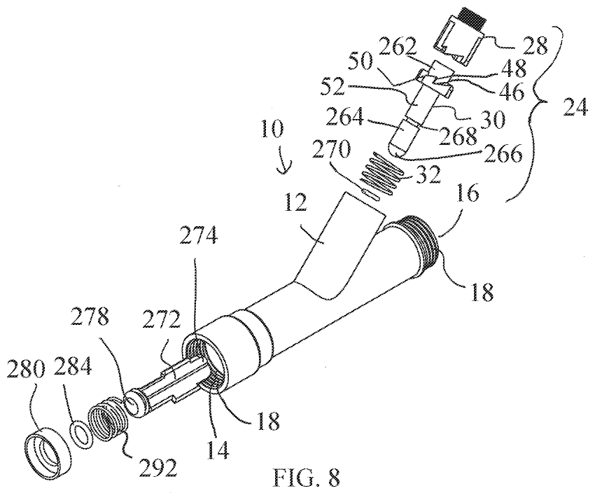

FIG. 8 is a perspective, exploded view of the device depicted in FIG. 7;

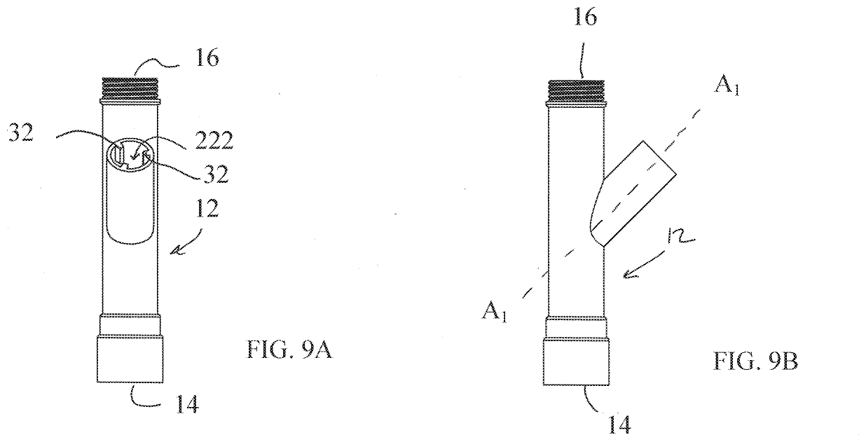

FIG. 9A is a top view of a body of the device depicted in FIG. 7;

FIG. 9B is a side view of the body of the device depicted in FIG. 7;

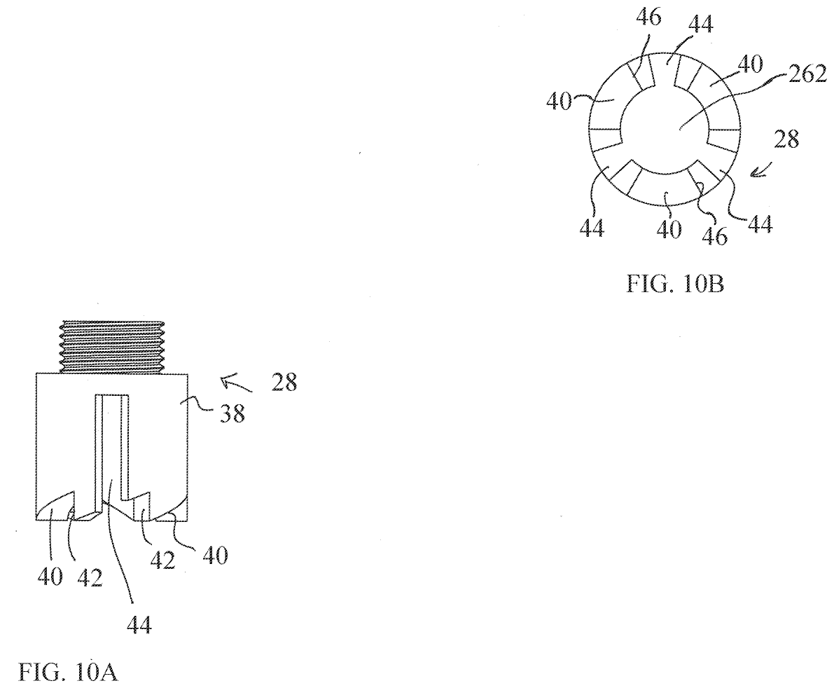

FIG. 10A is a front view of an upper button of the device depicted in FIG. 7;

FIG. 10B is a top view of the upper button of the device depicted in FIG. 7;

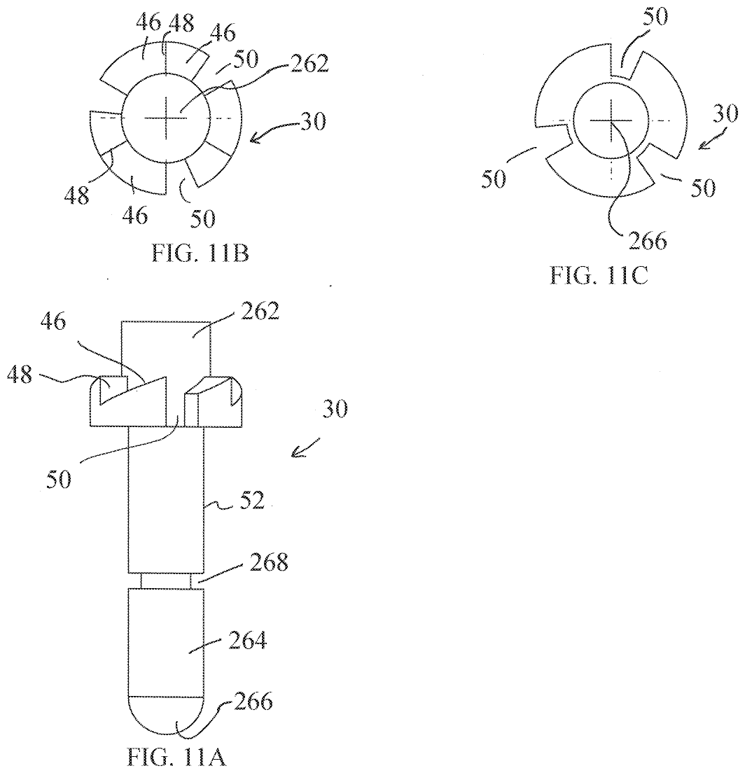

FIG. 11A is a side view of a lower cam from the device depicted in FIG. 7;

FIG. 11B is a top view of the lower cam from the device depicted in FIG. 7;

FIG. 11C is a bottom view of the lower cam from the device depicted in FIG. 7;

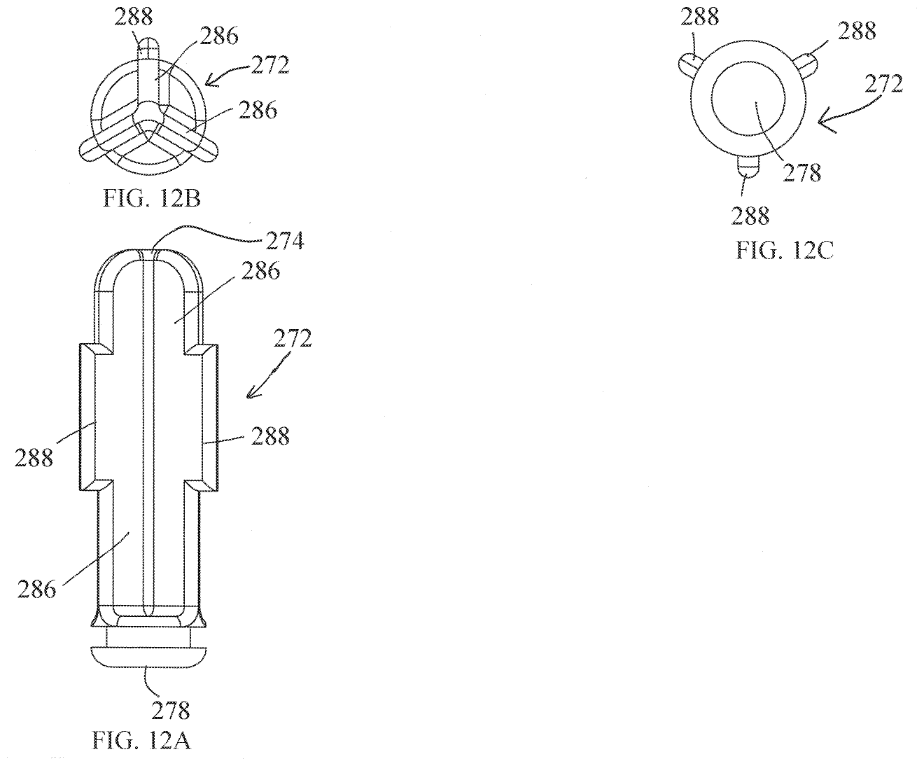

FIG. 12A is a top view of a moveable shaft from the device depicted in FIG. 7;

FIG. 12B is a rear view of the moveable shaft from the device depicted in FIG. 7; and,

FIG. 12C is a front view of the moveable shaft from the device depicted in FIG. 7.

### DETAILED DESCRIPTION OF THE INVENTION

As mentioned above, a new liquid flow regulation device has been invented. The new device controls the flow of liquid via a push-button actuating mechanism. Thus, with the push of a button, the flow of liquid can be started or stopped. The button could be pushed with a hand, foot, finger, or other body part. For example, the liquid flow regulation device could be utilized in a step-on control device which allows for a user to control the flow of water from a spigot by stepping on a water pressure to a hose can controlled without having to return to the spigot each and every time. However, this is just merely one example of a use of the new liquid flow regulation device.

With these general principles in mind, various embodiments of the present invention will be described with the understanding that the following description is not intended to be limiting.

As shown in FIGS. 1-3, 7, and 8 the new flow regulation device 10 includes a body 12 having a first end 14 and a second end 16. One of the first and second ends 14, 16 is an inlet opening and configured to receiving a fluid, for example water, and the other end 14, 16 is an outlet opening configured to provide the water when desired. In the following description, it will be described that the first end 14 is the inlet opening, the second end 16 is the outlet opening, and the fluid is water. Again, this is merely exemplary.

The body 12 is hollow so that, when desired, water is permitted to flow from the first end 14 to the second end 16. The first and second ends 14, 16 may each include, for example, a threaded surface 18, 20 which are configured to correspond to a complementarily configured surface on another conduit or device—one of which supplies the liquid to the device 10. Other attachments means may be utilized to secure to the device 10 to a water source and optionally, to another device. Thus, it is contemplated that the water freely flows out of the second end 16. However, it is likewise contemplated that the second end 16 is secured to another device (hose, sprinkler, sprayer, other conduit).

The body 12 of the device also includes a cavity 22 containing an actuating means 24 for stopping and starting the flow of water through the device 10.

Turning to a first embodiment shown in FIGS. 1 to 5C the cavity 22 has a longitudinal axis A1-A1 that is perpendicular to a longitudinal axis of the body 12 (not shown but extending from the first end 14 to the second end 16). A removable cap 26 is secured to the device 10 to allow for selective access to the inside of the cavity 22.

The actuating means 24 includes an upper button 28 and a lower cam 30. Both the upper button 28 and the lower cam 30 are biased by at least one spring 32 in a direction away from the removable cap 26.

As shown in FIGS. 4A to 4C, extending way from a bottom surface 34 of the upper button 28 is a wall 38. The wall 38 is formed by one or more ramps 40, stops 42, and gaps 44 that are configured to correspond with ramps 46, stops 48, and gaps 50 on the lower cam 30 (discussed below). Additionally, the cavity 22 includes one or more protrusions 36 that correspond with the gaps 44 in the upper button and provide the upper button 28 with the desired orientation and prevent the rotation of the upper button 28.

As shown in FIGS. 5A to 5C, the lower cam 30 also includes a body 52 with a through hole 54 extending through the body 52 that, when in the proper alignment, allows water to flow, from the first end 14, through the cavity 22, and out of the device 10 at the second end 16. When the through hole 54 is not aligned, the body 52 of the lower cam 30 prevents water from flowing from the first end 14, through the cavity 22, and out of the device 10 at the second end 16.

Accordingly, in a known manner, when assembled, the ramps 46, stops 48, and gaps 50 of the lower cam 30 contact the ramps 40, stops 42, and gaps 44 on the upper button 28. A center post 55 extending away from the body 52 of the lower cam 30 is received in a center cavity 57 in the upper button 28.

When the upper button 28 is depressed by a user (downward as viewed in FIGS. 1 and 2), the upper button 28 forces the lower cam 30 downward. As a result of the interactions between the ramps 40, 46, stops 42, 48, gaps 44, 50, and the protrusions 36 in the cavity 22, the lower cam 30 rotates 45 degrees.

When the user releases the upper button 28, the spring 32 urges the upper button 28 upward. When the upper button 28 reaches its terminal position (typically via an external device not shown), the spring 32 continues to urge the lower cam 30 upward, and due to the interactions between the ramps 40, 46, stops 42, 48, gaps 44, 50 and the protrusions 36 in the cavity 22, the lower cam 30 rotates another 45 degrees.

Thus, a 90 degree rotation will be accomplished by depressing and releasing the upper button 28, changing the orientation of the through hole 54 to either align the through hole 54 with the first and second ends 14, 16, allowing the flow of water through the body 12, or to mis-align the through hole 54 with the first and second ends 14, 16, allowing the body 52 to prevent the flow of water. To change the orientation of the through hole 54, a user depresses the button 28, again in the same direction as before, and the lower cam 30 will be rotated 90 degrees (45 degrees on the downstroke and 45 degrees on the upstroke).

The device 10 also includes seals, gaskets, O-rings, and other means for prevent liquid from leaking or flowing in an unintended or undesired path. An exemplary gasket 60 is shown in FIGS. 6A-6C. The gasket 60 includes first and second ends 62, 64. The first end 62 is cylindrical corresponding the shape of the body 12 of the device 10. The second end 64 has a non-planar outer edge 66 that is shaped to have an arc-shape (when viewed from the top) so that the body 52 of the lower cam 30 sits in the second end 64 of the gasket 60. Thus, when the through hole 54 is aligned for water flow, the gaskets 60 reduce or minimize water flow in an undesired flow path. When the through hole 54 is misaligned, only the upstream gasket 60 with provide a seal to minimize undesired water flow. The shape of the second end 64 allows the gasket 60 to accommodate the rotational movement of the body 52 of the lower cam 30. Other configurations can be utilized, and the depicted structure is only intended to be exemplary.

Turning to FIGS. 7 to 12C, a second embodiment is shown in which the same features from the first embodiment are identified with the same reference numbers and the above description is applicable herein mutatis mutandis.

In this embodiment, as shown in FIGS. 7 and 9B, a cavity 222 is provided in the device 10 which has a longitudinal axis A1-A1 that is angled between 90 and 180 degrees relative to the longitudinal axis of the body 12 (not shown but extending from the first end 14 to the second end 16).

The cavity 222 in this embodiment also includes protrusions 36 spaced radially so as to receive gaps 44 in the wall 38 on the upper button 28 so as to prevent the upper button 28 from rotating. Again, the spring 32 is included to bias the upper button 28 in a direction away from the device 10 (upward and to the right based on orientation shown in FIG. 7).

The body 52 of the lower cam 30 in the second embodiment includes an upper portion 260 that protrudes through that a central aperture 262 in the upper button 28. A lower portion 264 of the body 52 of the lower cam 30 terminates in a tip 266 of the body 52. The ramps 46, stops 48, and gaps 50 of the lower cam 30 are disposed between the upper and lower portions 260, 264 of body 52 of the lower cam 30. A groove 268 may be located in the lower portion 264 for an O-ring 270 which is used to ensure water does not leak out of the top of the cavity 222.

In the second embodiment, a moveable shaft 272 is located within the body 12 of the device 10. The moveable shaft 272 includes a first end 274 that is contacted by the tip 266 of the body 52 of the lower cam 30. A second end 276 of the shaft 272 forms a head 278. The head 278 is surrounded by an annular seal 280. The annular seal 280 sits on an annular seal seat 282 which is located in the body 12. Water is prevented from flowing from the first end 14 to the second end 16 by the annular seal 280 engaging the annular seal seat 282. An O-ring 284 may be disposed on the shaft 272 to create a fluid tight arrangement between the annular seal 280 and the shaft 272.

The moveable shaft 272 moves between a blocking position and a free position. In the blocking position, the annular seal 280 contacts the annular seal seat 282 and water is prevented from flowing past the annular seal 280. In the free position, the annular seal 280 does not contact the annular seal seat 282, and water is free to flow past the annular seal 280 and out of the second end 16. The moveable shaft 272 is selectively moved between the blocking position and the free position by the actuating means 24.

Specifically, as with the first embodiment, the depression of the upper button 28 also forces the lower cam 30 towards the device 10 (which is downward and to the left based on the orientation shown in the FIGS.). Since the tip 266 of the body 52 of the lower cam 30 contacts with the first end 274 of the moveable shaft 272, and the moveable shaft 272 is axially displaced (to the left based on the orientation shown in FIG. 7) and moved from the blocking position and the free position as the annular seal 280 is disengaged from the annular seal seat 282.

When the upper button 28 is released, the lower cam 30, rotated as a result of the gaps 50 clearing the protrusions 36 and, in a known manner, due to the interactions between the ramps 40, 46, stops 42, 48, gaps 44, 50, is prevented from moving back to its original position by elevated the protrusions 36 engaging stops 48. Since the lower cam 30 does not return to its original position, the contact between the tip 266 of the body 52 of the lower cam 30 and the first end 274 of the moveable shaft 272 prevents the moveable shaft 272 from returning to the blocking position, and water flows past the annular seal 280.

The moveable shaft 272 includes a plurality of wings 286, to provide a space for the water to flow. Additionally, the wings 286 can include an extension 288 that is received in a slot 290 in the body 12 of the device 10. The interaction between the extensions 288 of the wings 286 and the slots 290 in the body 12 maintain the orientation and limit the movement of the moveable shaft 272 within the body of the device 10.

To stop the flow of water from the device 10, the upper button 28 is depressed again. Again, due to the interactions between the ramps 40, 46, stops 42, 48, gaps 44, 50 and the protrusions 36 in the cavity 222, the lower cam 30 rotates to a position where it is not prevented from returning to its original position. As the upper button 28 and lower cam 30 return to their original positions, the tip 266 of the body 52 of the lower cam 30 no longer forces the moveable shaft 272 to remain in the free position. Accordingly, the water flowing through the device 10 forces the annular seal 280 into engagement with the annular seal seat 282. Thus, the shaft 272 is returned to the blocking position, either by a spring 292 urging the extensions 288 on the wings 286, or simply because of the force of water.

Accordingly, with the present flow regulation device 10, the user does not need to grip a spigot to start and stop water. Rather, a mere push of a button starts/stops the water flow. Additionally, the direction of actuation (i.e., the direction of pushing the upper button 28) is the same in both starting the flow of water and stopping the flow of water.

It should be appreciated and understood by those of ordinary skill in the art that various other components were not shown in the drawings as it is believed that the specifics of same are well within the knowledge of those of ordinary skill in the art and a description of same is not necessary for practicing or understanding the embodiments of the present invention. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A liquid flow regulation device comprising:
a body having an inlet opening and an outlet opening and cavity between the inlet and outlet openings; and,
an actuating means disposed in the cavity configured to start and stop the flow of liquid through said liquid flow regulation device,
wherein the actuating means is configured to be moved in a first direction to start a flow of liquid through said device and in the first direction to stop the flow of liquid through said device.

2. The flow regulation device of claim 1, wherein the cavity has a longitudinal axis that is perpendicular to an axis of the device extending from the inlet opening to the outlet opening.

3. The flow regulation device of claim 1, wherein the cavity has a longitudinal axis that is angled between 90 and 180 relative to an axis of the device extending from the inlet opening to the outlet opening.

4. The flow regulation device of claim 1, wherein the actuating means comprises an upper button and a lower cam.

5. The flow regulation device of claim 4, wherein the lower cam comprises a surface with a configuration formed by one or more ramps, stops, and gaps, and wherein the upper button has a lower surface with a complementary configured configuration formed by one or more ramps, stops, and gaps.

6. The flow regulation device of claim 4, wherein the lower cam comprises a center post configured to receive a center cavity in the upper button.

7. The flow regulation device of claim 4, further comprising:
a spring urging the lower cam towards the upper button.

8. The flow regulation device of claim 4, wherein the lower cam comprises a body with a through hole that in an alignment configuration, allows the flow of liquid, from the inlet opening, through the cavity, and out of the flow regulation device at the outlet opening.

9. The flow regulation device of claim 8, further comprising a gasket comprising a first end and a second end and disposed between one of the inlet opening and the outlet opening and the body of the lower cam.

10. The flow regulation device of claim 9, wherein the first end of the gasket corresponds to the body of the device, and
wherein the second end of the gasket has a non-planar outer edge that is shaped to have an arc-shape, when viewed from the top, so that the body of the lower cam sits in the second end of the gasket.

11. The flow regulation device of claim 4 further comprising:
a moveable shaft engaging the lower cam, the moveable shaft having an annular seal configured to engage a seal seat and to move between a blocking position and a free position, and
wherein in the blocking position the annular seal contacts the seal seat and prevents the flow of liquid passed the annular seal.

12. The flow regulation device of claim 11 further comprising:
a spring biasing the moveable shaft in the blocking position.

13. The flow regulation device of claim 11 wherein the moveable shaft further comprises a plurality of wings to provide space for the flow of liquid.

14. The flow regulation device of claim 13, wherein one or more of the wings from the plurality of wings include an extension, the extension received in a slot in the body of the device.

15. A liquid flow regulation device comprising:
a body having an inlet opening and an outlet opening and cavity between the inlet and outlet openings, wherein the cavity has a longitudinal axis that is perpendicular to an axis of the device extending from the inlet opening to the outlet opening; and,
an actuating means disposed in the cavity configured to start and stop a flow of liquid through said liquid flow regulation device,
wherein the actuating means comprises an upper button and a lower cam,
wherein the lower cam comprises a through hole for liquid to pass therethrough and a surface with a configuration formed by one or more ramps, stops, and gaps, and
wherein the upper button has a lower surface with a complementary configured configuration formed by one or more ramps, stops, and gaps.

16. A liquid flow regulation device comprising:
a body having an inlet opening and an outlet opening and cavity between the inlet and outlet openings, wherein the cavity has a longitudinal axis that is angled between 90 and 180 relative to an axis of the device extending from the inlet opening to the outlet opening; and,
an actuating means disposed in the cavity configured to start and stop a flow of liquid through said liquid flow regulation device,
wherein the actuating means comprises an upper button, a lower cam, and a moveable shaft engaging the lower cam, the moveable shaft having an annular seal configured to engage a seal seat and to move between a blocking position and a free position, and
wherein in the blocking position the annular seal contacts the seal seat and prevents the flow of liquid passed the annular seal,
wherein the lower cam comprises a surface with a configuration formed by one or more ramps, stops, and gaps,
wherein the upper button has a lower surface with a complementary configured configuration formed by one or more ramps, stops, and gaps, and
wherein the moveable shaft further comprises a plurality of wings to provide space for the liquid to flow.
